(19) United States
(12) Patent Application Publication
(10) Pub. No.: US 2008/0316893 A1
(43) Pub. Date: Dec. 25, 2008

(54) Reproducing Device and Method

(76) Inventors: Shogo Miyanabe, Saitama (JP); Hiroki Kuribayashi, Saitama (JP)

Correspondence Address: YOUNG & THOMPSON, 209 Madison Street, Suite 500, ALEXANDRIA, VA, 22314, US

(21) Appl. No.: 11/628,309

(22) PCT Filed: Jun. 2, 2005
(86) PCT No.: PCT/JP05/10172

§ 371 Date: Jul. 18, 2007

(30) Foreign Application Priority Data
Jun. 2, 2004 (JP) 2004-164146

(51) Int. Cl. G11B 7/00

(52) U.S. Cl. 369/100; G9B/7

(57) ABSTRACT

A reproducing device is provided with a beam irradiating means, which irradiates one track on a recording medium with a main beam and irradiates a position deviated from the irradiation position of the main beam with a sub beam; a main signal detecting means for outputting a main reproduction signal based on the main beam; a sub signal detecting means, which is divided by a dividing line along the tangent line direction of the one track, has a plurality of light receiving parts including a first light receiving part on a side close to the one track, and outputs a plurality of sub reproduction signal corresponding to detection light from the plurality of light receiving parts; a delaying means for relatively delaying the main reproduction signal and the sub reproduction signal; a delay quantity setting means for setting a delay quantity; and a crosstalk canceller for removing crosstalk from the delayed main reproduction signal. The sub signal detecting means outputs a first sub reproduction signal corresponding to the detection light from a first light receiving part, and the delay quantity setting means sets the delay quantity by using the first sub reproduction signal.

### TECHNICAL FIELD

The present invention relates to a reproducing apparatus for and a reproducing method of removing a crosstalk component which comes from an adjacent track, from a reproduction signal which is a reading target, on the basis of a plurality of reproduction signals obtained by irradiating a recording medium, such as an optical disc, for example, with a plurality of beams.

### BACKGROUND ART

In this kind of reproducing apparatus, a technology of removing crosstalk from a reproduction signal becomes more important, along with the density growth of a recording medium. For example, on a 3-beam crosstalk canceller based on a DPP (Differential Push Pull) method, for example, with regard to the recording medium, such as the optical disc, not only a main track which is a reading target, but also two adjacent tracks on the both sides thereof are irradiated with beam light, to thereby obtain reproduction signal outputs corresponding to the respective tracks. Then, by a process of subtracting the reproduction signal of the adjacent track or the like, the crosstalk component which comes from the adjacent track is removed from the reproduction signal of the main track.

In such a process, it is important that the phases of the three reproduction signals are uniform. As opposed to this, since the track pitch of the optical disc is narrow, the three beams are relatively separated at predetermined intervals in a track reproduction direction, which causes a phase shift depending on the intervals of the beams, in the reproduction signal. Thus, normally, the reproduction signal is delayed on a FIFO memory or the like, to thereby correct the phase shift among the three reproduction signals.

However, if the wavelength of the beam light is changed due to a change in temperature or the like, then, in accordance with that, the amount that the signal is to be delayed is also changed. Thus, the delay amount needs to be optimized, constantly. For example, in a patent document 1, there is described a technology of adjusting the delay, on the basis of maximizing a correlation between the reproduction signal of the main track and the reproduction signal of the adjacent tracks. Moreover, in a patent document 2, there is described a technology of adjusting the delay, so as to minimize the reproduction jitter of the main track.

patent document 1: Japanese Patent Application Laid Open NO. Hei 7-176052
patent document 2: Japanese Patent Application Laid Open NO. 2000-173061

### DISCLOSURE OF INVENTION

### Subject to be Solved by the Invention

However, in each of the above-mentioned technologies, basically, the delay adjustment is performed by using a shift in time of the crosstalk component between the adjacent tracks, so that there is such a technical problem that it is difficult to properly adjust the delay if the crosstalk is small. Namely, the small crosstalk causes the small correlation between the reproduction signal of the main track and the reproduction signal of the adjacent track. Thus, as in the patent document 1, if the correlation between the both signals is just adopted, information in which the detection sensitivity is adjusted to the phase shift between the both signals is obtained. Thus, the delay adjustment based on this has a low accuracy. Moreover, according to the technology described in the patent document 2, if the crosstalk from the adjacent track is small, a change in the jitter is small before and after the crosstalk canceling, so that it is difficult to perform the sufficient delay adjustment.

Moreover, in each of the above-mentioned technologies, the crosstalk is detected by using the reproduction signals of the adjacent tracks, so that the delay adjustment is premised on the signal detection of at least three tracks. Thus, if the adjacent tracks are unrecorded, there is no crosstalk. Thus, in that case, there is also such a technical problem that the delay adjustment cannot be properly performed.

It is therefore an object of the present invention to provide a reproducing apparatus and a reproducing method capable of properly setting the delay amount in the phase shift correction between the reproduction signals.

### Means for Solving the Subject

### (Reproducing Apparatus)

The above object of the present invention can be achieved by a reproducing apparatus provided with: a beam irradiating device for irradiating a main beam onto one track which is a reading target on a recording medium, and for irradiating a sub beam onto a position shifted from an irradiated position of the main beam; a main signal detecting device for detecting light from the recording medium based on the irradiated main beam and for outputting a main reproduction signal; a sub signal detecting device having a plurality of light receiving portions including a first light receiving portion on a side closer to the one track and divided in a dividing line along a tangential direction of the one track, the sub signal detecting device for outputting a plurality of sub reproduction signals including a first sub reproduction signal corresponding to light from the recording medium based on the sub beam detected by the first light receiving portion; a delay device for relatively delaying one of the outputted main reproduction signal and at least one of the outputted plurality of sub reproduction signals, with respect to the other signal; a delay amount setting device for setting a delay amount of the delay device, on the basis of the first sub reproduction signal; and a crosstalk canceller for removing crosstalk caused by another track adjacent to the one track, from the outputted main reproduction signal, on the basis of an output of the delay device.

According to the reproducing apparatus of the present invention, at the time of the operation thereof, the crosstalk canceling is performed by using the sub reproduction signal based on the sub beam, with respect to the main reproduction signal read from the one track (hereinafter referred to as a “main track”, as occasion demands) on the recording medium on the basis of the main beam. Here, the sub beam is irradiated onto the position shifted from the irradiated position of the main beam. The “shifted position” in the present invention means a position displaced in both a direction along the track and a direction of crossing the track.

Then, on the main signal detecting device, the light from the recording medium based on the main beam is detected, and the main reproduction signal is outputted. In the meanwhile, on the sub signal detecting device, the first sub reproduction signal and the other sub reproduction signal or signals (which may include the first sub reproduction signal) are obtained, with respect to one sub beam. The plurality of sub reproduction signals are outputted from the respective plurality of light receiving portions divided in the dividing line along the tangential direction of the main track, on the sub signal detecting device.

Namely, the “main reproduction signal” of the present invention means a signal outputted in accordance with the light detected by the main signal detecting device. Moreover, the “sub reproduction signal” of the present invention means a signal outputted in accordance with the light detected by the sub signal detecting device. There are the plurality of light receiving portions, so that the plurality of sub reproduction signals are outputted. In particular, the plurality of sub reproduction signals include the first sub reproduction signal.

Moreover, with regard to the sub signal detecting device, the “dividing line along the tangential direction of the one track (the main track)” in the present invention is such a concept that the dividing line of the present invention only needs to be along the direction optically corresponding to the tangential direction of the one track. For example, if the sub signal detecting device receives light through a mirror and a prism, the tangential direction is curved with the curve of an optical path. Incidentally, the tangential direction of the one track means the tangential direction of the track if the track is concentric, such as the case where the recording medium is a disc, and it means a direction of extending the track if the track is linear.

The first sub reproduction signal is a selected output from the first light receiving portion on the side closer to the main track, and it includes a signal component read from the main track. The other sub reproduction signal or signals mainly includes a component read from an area shifted from the main track in its crossing direction. This component is read not from the main track but from its vicinity, so that it can be regarded as the index of the crosstalk which is mixed in the main reproduction signal.

Moreover, in order to remove the phase difference between the main reproduction signal and the sub reproduction signal outputted from the respective detecting devices before the application to the crosstalk canceling, one of them is delayed with respect to the other on the delay device. The sub reproduction signal which is delayed at that time or which is the reference of delaying the main reproduction signal, may be at least one of the sub reproduction signals outputted from the sub signal detecting device.

Here, the delay amount of the delay device is set in a signal process using the first sub reproduction signal, on the delay amount setting device. Namely, the “delay amount setting device” of the present invention sets the delay amount in order to synchronize the main reproduction signal outputted from the main signal detecting device with at least one of the sub reproduction signals outputted from the sub signal detecting device.

As described above, the first sub reproduction signal has a higher ratio of the signal component read from the main track (i.e. the signal with the same waveform as that of the main reproduction signal) than the other sub reproduction signal or signals. Thus, the first sub reproduction signal can be regarded as the main reproduction signal detected in different timing, and the delay amount of the sub reproduction signal with respect to the main reproduction signal is obtained as the phase shift of the main reproduction signal itself. As will be understood, the correlation between the same signals (i.e. the main reproduction signals) is strong, so that the phase shift, i.e. the delay amount, can be captured, relatively clearly, without being buried in noises.

As described above, by setting the main reproduction signal component in the sub reproduction signal as the index, it is possible to detect the delay amount, highly accurately and stably. Moreover, with regard to the setting of the delay amount, the reproduction signal needs to be detected at least only from the main track. Moreover, regardless of the extent of the crosstalk in the main reproduction signal, it is possible to obtain the delay amount with constant accuracy.

In one aspect of the reproducing apparatus of the present invention, the delay amount setting device detects a delay error between the first sub reproduction signal and the main reproduction signal relatively delayed by the delay device, and sets the delay amount in accordance with the delay error.

According to this aspect, there is a reference value substantially set for the delay amount of the delay device, and the delay amount setting device adjusts the delay amount by using the delay error with reference to the reference value. The main reproduction signal and the first sub reproduction signal, if out of phase only by the reference value, are in phase after relatively delayed by using the delay device. If there is the phase shift with reference to the reference value, it is detected as the delay error after the delay. As described above, by adjusting the delay amount by using the actual delay error, which is obtained on the basis of the signal after delayed, it is possible to set the more correct delay amount.

In an aspect of setting the delay amount in accordance with the delay error, the reproducing apparatus is further provided with a signal selecting device for changing the outputted plurality of sub reproduction signals for the delay amount setting device and for the crosstalk canceller, and for selectively outputting the signals to the delay device.

According to this aspect, the sub reproduction signals are selected and inputted to the delay device for each application. The sub reproduction signals outputted by the sub signal detecting device are divided into the first sub reproduction signal used on the delay amount setting device and the other sub reproduction signal or signals used on the crosstalk canceller. Here, the sub reproduction signals are selectively outputted to the delay device in accordance with the above difference, so that even if the same delay device is used, it is possible to separate the first sub reproduction signal from the other reproduction signal or signals and to independently delay it. Thus, it is possible to embody the configuration for obtaining the delay error and perform both the delay correction and the crosstalk canceling, normally.

In another aspect of the reproducing apparatus of the present invention, the crosstalk canceller is controlled in a condition that the crosstalk is not removed from the outputted main reproduction signal at the time of delay adjustment.

According to this aspect, the crosstalk canceller is controlled substantially not to perform the crosstalk canceling, at the time of the operation of the delay amount setting device. Namely, even if the cross canceller and the delay amount setting device are wired so as to input signals thereto from the same route, the both devices have different operation timing, so that it is prevented that the one's own input signal is inputted to the other by mistake. Thus, it is possible to normally perform both the delay correction and the crosstalk canceling.

In another aspect of the reproducing apparatus of the present invention, the plurality of light receiving portions include a second light receiving portion on a side farther from the one track, and the crosstalk canceller removes the crosstalk by using a second sub reproduction signal corresponding to light from the recording medium based on the sub beam detected by the second light receiving portion out of the sub reproduction signals.

According to this aspect, the crosstalk canceling is performed on the basis of the second sub reproduction signal. The second sub reproduction signal is the reproduction signal in an area much farther from the main track, out of the sub beam irradiated areas. Thus, the ratio of the signal component read from the adjacent track (i.e. the crosstalk component) is higher than that of the signal component read from the main track (i.e. the signal with the same waveform as that of the main reproduction signal). Therefore, in the crosstalk canceling in this case, the crosstalk component is mainly removed from the main reproduction signal, and the same waveform component is hardly removed, so that it is possible to maintain a good S/N ratio of the final output of the main reproduction signal.

As described above, if the sub reproduction signals are selectively used in accordance with the reading position depending on the purpose of each process, such as the first sub reproduction signal for the delay adjustment and the second sub reproduction signal for the crosstalk canceling, it is possible to perform each of the processes, accurately.

In another aspect of the reproducing apparatus of the present invention, the sub beam is irradiated centered on a gap between the one track and the another track.

According to this aspect, the sub beam is irradiated centered on the middle of the main track and the adjacent track, and the reproduction signals from both the main track and the adjacent track can be read from the area irradiated with one sub beam. At this time, the first sub reproduction signal has the reproduction signal from the main track, as the main component. The second sub reproduction signal has the reproduction signal from the adjacent track as the main component. Thus, it can be considered that the first sub reproduction signal indicates the main reproduction signal itself and that the second sub reproduction signal indicates the crosstalk component from the adjacent track. Therefore, it is possible to accurately perform the delay error detection based on the first sub reproduction signal, and the cross canceling based on the second sub reproduction signal.

In another aspect of the reproducing apparatus of the present invention, the delay amount setting device sets the delay amount on the basis of an amplitude difference between the main reproduction signal and the first sub reproduction signal.

According to this aspect, the delay error is obtained by using the fact that as the delay error increases more, the amplitude difference between the main reproduction signal and the first sub reproduction signal increases more. In the ideal condition that the main reproduction signal is completely synchronized with the sub reproduction signal, the amplitude difference is zero or extremely smaller than the other conditions. Thus, it is only necessary to detect the phase difference between the both signals when the amplitude difference is zero or minimum, as the delay amount or the delay error. This process can be realized in a relatively simple operation, and its load for the apparatus is small.

In an aspect of detecting the delay error on the basis of the amplitude difference between the main reproduction signal and the first sub reproduction signal, the delay amount setting device may perform adjustment of adding or subtracting an amplitude value of the first sub reproduction signal, by using a coefficient based on a correlation between the amplitude difference and the first sub reproduction signal.

In this case, if the delay amount is optimum, the amplitude of the first sub reproduction signal is adjusted such that the amplitude difference between the main reproduction signal and the first sub reproduction signal is zero or minimum. Thus, even if the signal level of the main reproduction signal is shifted from the signal level of the first sub reproduction signal, it is possible to perform the highly accurate detection of the delay amount or the delay error.

In another aspect of the reproducing apparatus of the present invention, the delay amount setting device sets the delay amount on the basis of a correlation between the main reproduction signal and the first sub reproduction signal.

According to this aspect, the delay amount or the delay error is obtained from the correlation between the main reproduction signal and the first sub reproduction signal. As described above, the first sub reproduction signal includes the component with the same waveform as that of the main reproduction signal. Thus, the correlation at this time is regarded as the autocorrelation of the main signal component. The correlation is maximum when the main reproduction signal is completely synchronized with the sub reproduction signal. Thus, it is only necessary to detect the phase difference at this time, as the delay amount or the delay error. Moreover, the S/N ratio of the correlation value is large, and on the basis of this, it is possible to obtain the delay amount or the delay error, highly accurately.

In another aspect of the reproducing apparatus of the present invention, the delay amount setting device sets the delay amount on the basis of a correlation between the first sub reproduction signal and an amplitude difference between the main reproduction signal and the first sub reproduction signal.

According to this aspect, the amplitude difference between the main reproduction signal and the first sub reproduction signal is obtained, and the correlation between the amplitude difference and the first sub reproduction signal is obtained. The amplitude difference is a signal obtained by subtracting the waveform component commonly included in the both signals, from the main reproduction signal. With regard to the correlation between the amplitude difference and the first sub reproduction signal, they are uncorrelated if the both signals are in phase (i.e. the delay amount is optimum). The mean value and the integrated value are zero or minimum. Therefore, the phase difference at this time may be detected as the delay amount or the delay error.

In another aspect of the reproducing apparatus of the present invention, at least one portion of the delay amount setting device is shared with the crosstalk canceller.

According to this aspect, by sharing at least one portion of the delay amount setting device with the crosstalk canceller, the circuit scale is reduced, to thereby realize a reduction in cost and a reduction in space. In this case, however, at least in the shared portion, it is necessary to perform the delay correction and the crosstalk canceling in different timing, to thereby ensure the normal operation.

In another aspect of the reproducing apparatus of the present invention, the beam irradiating device irradiates two beams separated by the main beam back and forth in a direction along the one track, as the sub beam, and the sub signal detecting device outputs the sub reproduction signals to two systems in response to each of the two beams.

According to this aspect, the sub reproduction signals are outputted to the two systems with reference to one main reproduction signal, so that it is possible to perform the crosstalk canceling, more highly accurately, by using the sub reproduction signals.

In an aspect of obtain the sub reproduction signals in the two systems, the delay amount of the sub reproduction signal corresponding to one of the two beams may be set on the basis of the delay amount of the sub reproduction signal corresponding to the other of the two beams, and a mutual distance between each of the two beams and the main beam.

According to this aspect, the delay amount between one of the two sub reproduction signals and the main reproduction signal is set on the basis of the delay amount of the other sub reproduction signal and the beam mutual distance, by using the fact that each delay amount has a proportional relation with the distance between the beams corresponding to the delay amount. One of the delay amounts is obtained from a simple equation for representing the proportional relation between the delay amount and the beam mutual distance. Moreover, actually, what is set on the basis of the phase difference between the reproduction signals, is only one of the delay amounts. Thus, the delay amount setting device only needs almost one system, which allows simplification in the apparatus structure and which allows a reduction by half in a processing time length related to the signal process.

### (Optical Disc Reproducing Method)

The above object of the present invention can be also achieved by a reproducing method provided with: a beam irradiating process of irradiating a main beam onto one track which is a reading target on a recording medium, and of irradiating a sub beam onto a position shifted from an irradiated position of the main beam; a main signal detecting process of detecting light from the recording medium based on the irradiated main beam and of outputting a main reproduction signal; a sub signal detecting process, using a sub signal detecting device having a plurality of light receiving portions including a first light receiving portion on a side closer to the one track and divided in a dividing line along a tangential direction of the one track, to thereby detect light from the recording medium based on the sub beam from each of the plurality of light receiving portions, and output a plurality of sub reproduction signals including a first sub reproduction signal corresponding to light from the recording medium detected by the first light receiving portion; a delay process of relatively delaying one of the outputted main reproduction signal and at least one of the outputted plurality of sub reproduction signals, with respect to the other signal; a delay amount setting process of setting a delay amount in the delay, on the basis of the first sub reproduction signal; and a crosstalk canceling process of removing crosstalk caused by another track adjacent to the one track, from the outputted main reproduction signal, on the basis of at least one of the plurality of sub reproduction signals, after the delay process.

The reproducing method of the present invention provides the same operation and effects as those of the above-mentioned reproducing apparatus of the present invention.

As explained above, according to the reproducing apparatus of the present invention, it is provided with the beam irradiating device, the main signal detecting device, the sub signal detecting device, the delay device, and the delay amount setting device. Thus, it is possible to properly set the delay mount in the phase difference correction between the reproduction signals.

Moreover, according to the reproducing method of the present invention, it is provided with the process of irradiating the sub beam in the area shifted in the cross direction from the main track, the process of outputting the sub reproduction signals including the first sub reproduction signal on the basis of the sub beam, the process of outputting the main reproduction signal, the process of relatively delaying the main reproduction signal and at least one of the sub reproduction signals, and the process of setting the delay amount by using the first sub reproduction signal Thus, it is possible to properly set the delay mount in the phase difference correction between the reproduction signals.

### BRIEF DESCRIPTION OF DRAWINGS

FIG. 1 is a block diagram showing the structure of a reproducing apparatus in a first embodiment of the present invention.

FIG. 2 is a block diagram showing one example of a delay adjusting device of the reproducing apparatus in the first embodiment.

FIG. 3 is a block diagram showing one example of a delay adjusting device of the reproducing apparatus in the first embodiment.

FIG. 4 are block diagrams showing the structure of a delay error detection circuit of the delay adjusting device in the first embodiment.

FIG. 5 are waveform diagrams showing the waveform examples of the reproduction signal after a delay process in the first embodiment and the output signal of the delay error detection circuit with respect to the input of the reproduction signal.

FIG. 6 are waveform diagrams showing the waveform examples of the reproduction signal after a delay process in the first embodiment and the output signal of the delay error detection circuit with respect to the input of the reproduction signal.

FIG. 7 are waveform diagrams showing a change in the output signal with respect to the phase shift of the reproduction signals, on the delay error detection circuit shown in FIG. 4(A).

FIG. 8 are waveform diagrams showing the change in the output signal with respect to the phase shift of the reproduction signals, on the delay error detection circuit shown in FIG. 4(A), if the inputted reproduction signals are different, as a comparison example.

FIG. 9 are waveform diagrams showing the change in the output signal with respect to the phase shift of the reproduction signals, on the delay error detection circuit shown in FIG. 4(B).

FIG. 10 are waveform diagrams showing the change in the output signal with respect to the phase shift of the reproduction signals, on the delay error detection circuit shown in FIG. 4(B), if the inputted reproduction signals are different, as a comparison example.

FIG. 11 is a block diagram showing the structure of a reproducing apparatus in a second embodiment.

FIG. 12 is a block diagram showing a configuration example of a delay adjusting device of the reproducing apparatus in the second embodiment.

FIG. 13 is a block diagram showing the structure of a reproducing apparatus in a third embodiment.

FIG. 14 is a block diagram showing the structure of a reproducing apparatus in a fourth embodiment.

FIG. 15 is a plan view for explaining a first modified example for the embodiments.

FIG. 16 is a block diagram showing the structure of a reproducing apparatus in the first modified example.

FIG. 17 is a plan view for explaining the second modified example for the embodiments.

### DESCRIPTION OF REFERENCE CODES

1 . . . beam irradiation device, 2a, 2b, 2c . . . detector, 31, 32, 35 . . . selector, 4a, 4b, 4c, 41 to 45 . . . A/D converter, 5a, 5b, 5c, 51 to 54 . . . Delay device, 6. 16. 26. 106 . . . delay adjusting device, 60, 60a, 60b . . . delay error detection circuit, 70 . . . delay control device, 7 . . . crosstalk canceller (CTC), 8 . . . binary device, Bm . . . main beam, B1, B2 . . . sub beam, Tm . . . main track, Tr1, Tr2 . . . adjacent track, Sm, S1f, S1n, S2f, S2n . . . (analog) reproduction signal, Dm, D1f, D1n, D2f, D2n, Dmc . . . (digital) reproduction signal, Pm . . . information reproduction signal, e1, e2 . . . error signal, Δτ1, Δτ2 . . . delay error.

### BEST MODE FOR CARRYING OUT THE INVENTION

Hereinafter, the best mode for carrying out the invention will be explained in each embodiment in order, with reference to the drawings.

Hereinafter, the embodiments of the present invention will be explained with reference to the drawings.

### First Embodiment

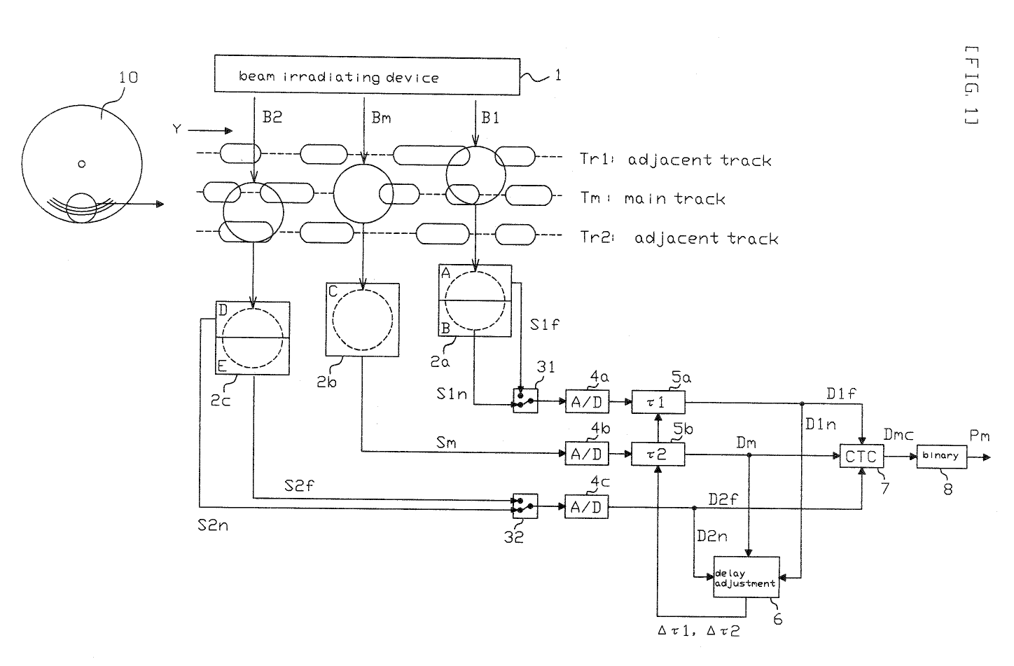

The first embodiment of the present invention will be explained with reference to FIG. 1 to FIG. 10.

### (Entire Structure of Reproducing Apparatus)

Firstly, the entire structure of a first reproducing apparatus will be explained with reference to FIG. 1. FIG. 1 is the main structure of the reproducing apparatus in the first embodiment.

In FIG. 1, the reproducing apparatus in the first embodiment is provided with: a beam irradiation device 1; detectors 2a, 2b, and 2c; A/D converters 4a, 4b, and 4c; delay devices 5a and 5b; a delay adjusting device 6; a crosstalk canceller (hereinafter abbreviated as CTC) 7; and a binary device 8. This reproducing apparatus basically applies a 3-beam crosstalk canceller, to thereby remove crosstalk on a reproduction signal. Namely, the beam irradiation device 1 is constructed to emit a main beam Bm onto a main track Tm, which is a reading target on an optical disc 10, and to emit sub beams B1 and B2, relatively separated from the main beam Bm at predetermined intervals in a direction along the main track Tm, and to remove the crosstalk in the reproduction signal caused by the main beam Bm, by using the reproduction signals due to the sub beams B1 and B2.

The beam irradiation device 1 may be constructed to generate and output the main beam Bm and the sub beams B1 and B2 from three beam generation sources, such as three semiconductor laser apparatuses, for example. Alternatively, the beam irradiation device 1 may be constructed to diffract light generated from one semiconductor laser apparatus in three directions by using diffraction grating, or to divide it by using a beam splitter, a half mirror, a dichroic mirror, or the like, to thereby obtain the three beams.

Moreover, here, the sub beams B1 and B2 are emitted onto respective areas, shifted from the main track Tm to the outer and inner circumferential sides of the optical disc 10 (i.e. shifted in a direction of crossing the main track Tm), particularly, areas centered on the gaps between the main track Tm and respective adjacent tracks Tr1 and Tr2 adjacent to the main track Tm.

The detectors 2a, 2b, and 2c are constructed to detect light, e.g. reflected light, diffracted light, or transmitted light, from the optical disc 10, on the basis of the sub beam B1, the main beam Bm and the sub beam B2, respectively, and to output the reproduction signal corresponding to the detected light. A reproduction signal Sm is outputted from the detector 2b provided with a light receiving element C. The detector 2a is provided with light receiving elements A and B divided by a dividing line along a direction optically corresponding to the tangential direction of tracks of the optical disc 10. The detector 2a outputs a reproduction signal S1f from the light receiving element A on the side farther from the main track Tm, and a reproduction signal S1n from the light receiving element B on the side closer to the main track Tm. The detector 2c is provided with light receiving elements D and E bipartite in the same manner, and outputs a reproduction signal S2n from the light receiving element D and a reproduction signal S2n from the light receiving element E.

The A/D converters 4a, 4b, and 4c are provided in association with the detectors 2a, 2b, and 2c, respectively, and have a function of performing digital conversion on the reproduction signals S1f and S1n, the reproduction signal Sm, and the reproduction signals S2f and S2n, and of outputting reproduction signals D1f and D1n, a reproduction signal Dm, and reproduction signals D2f and D2n, respectively. Incidentally, one of the reproduction signals S1f and S1n are selected by a selector 31 and inputted to the A/D converter 4a, and one of the reproduction signals S2f and S2n are selected by a selector 32 and inputted to the A/D converter 4c.

The delay devices 5a and 5b are disposed at the subsequent stage of the A/D converters 4a and 4b, respectively, and delay the output from the A/D converter 4a (i.e. the reproduction signals D1f or D1n from the detector 2a) and the output from the A/D converter 4b (i.e. the reproduction signal Dm from the detector 2b), with respect to the output of the A/D converter 4c (i.e. the reproduction signal D2f or D2n from the detector 2c), respectively, to thereby function to match the phase between them. This is equivalent to a process of eliminating a phase difference between the reproduction signal Dm and the reproduction signals D1f and D1n, and/or a phase difference between the reproduction signal Dm and the reproduction signals D2f and D2n. As the delay amounts τ1 and τ2 of the delay devices 5a and 5b, standard values are set in advance depending on a time difference on the scanning between the sub beam B2 and the sub beam B1 and a time difference on the scanning between the sub beam B2 and the main beam Bm. Incidentally, the delay devices 5a and 5b are constructed from a FIFO memory, for example, and constructed to vary the delay amount.

The delay adjusting device 6 functions to adjust each of the delay amount amounts τ1 and τ2 by detecting delay errors Δτ1 and Δτ2 of the delay devices 5a an 5b and by returning them to the delay devices 5a an 5b. The specific construction will be descried later. Here, the operation timing of the delay adjusting device 6 is synchronously controlled with the timing that the selectors 31 and 32 output the reproduction signals D1 and Ds, respectively, and the reproduction signals Dm, D1n, and D2n are inputted to the delay adjusting device 6 for the purpose of delay adjustment.

The CTC 7 may function to remove the crosstalk components from the adjacent tracks Tr1 and Tr2, from the reproduction signal Dm which is a reading target, and may have the same structure as the normal one. Namely, the CTC 7 is disposed at the subsequent stage of the delay devices 5a and 5b, and outputs, as a reproduction signal Dmc, a signal that is obtained by subtracting a signal that is obtained by multiplying the reproduction signal D1n or D2n by a coefficient, from the reproduction signal Dm, after the delay adjustment. Moreover, the operation timing of the CTC 7 is synchronously controlled with the timing that the selectors 31 and the 32 output the reproduction signals D1f and D2f, respectively, and the reproduction signals Dm, D1n, and D2n are inputted to the CTC 7 for the purpose of crosstalk removal.

Namely, when the delay amount is adjusted by the delay adjusting device 6, the CTC 7 is controlled to the condition that it does not remove the crosstalk with respect to the reproduction signal Dm. When the delay amount is adjusted, the reproduction signals Dm, D1n, and D2n are also inputted to the CTC 7. As described later, the reproduction signals Dm, D1n, and D2n are regarded as almost the same signal, so that at that time, the CTC 7 malfunctions (i.e. operates to reduce the amplitude of the reproduction signal Dmc). However, if the operation of the CTC 7 is controlled to be OFF by replacing, by 0, an input signal value which allows a tap coefficient to be 0 during this time, it is possible to always perform stable signal reproduction.

As described above, the operation timing of the delay adjusting device 6 and the operation timing of the CTC 7 do not overlap, so that although they have the construction that the same signal is inputted thereto from the same route, it is prevented that they operate by using the signal to be obtained by the other by mistake and that they output the operation results. Incidentally, such timing control is performed by a not-illustrated control device.

The binary device 8 is provided with a DA converter, a comparator, or the like, for example, and converts the reproduction signal outputted by the CTC 7 to be analog, binarizes it, and outputs a pulse-shaped information reproduction signal Pm. Incidentally, the information reproduction signal Pm is transmitted to a digital video decoder or the like, for example, at the subsequent stage.

Incidentally, here, the detector 2b is a specific example of the “main signal detecting device” of the present invention, and the detectors 2a and 2c are a specific example of the “sub signal detecting device” of the present invention. Moreover, the light receiving elements B and D correspond to the “first light receiving portion” of the present invention, and the light receiving elements A and E correspond to the “second light receiving portion” of the present invention. Moreover, the reproduction signals Sm and Dm are a specific example of the “main reproduction signal” of the present invention, the reproduction signals D1n and D2n are a specific example of the “first sub reproduction signal” of the present invention, and the reproduction signals D1f and D2f are a specific example of the “second sub reproduction signal” of the present invention. The delay adjusting device 6 is a specific example of the “delay amount setting device” of the present invention. The selectors 31 and 32 are a specific example of the “signal selecting device” of the present invention.

### (Structure of Delay Adjusting Device)

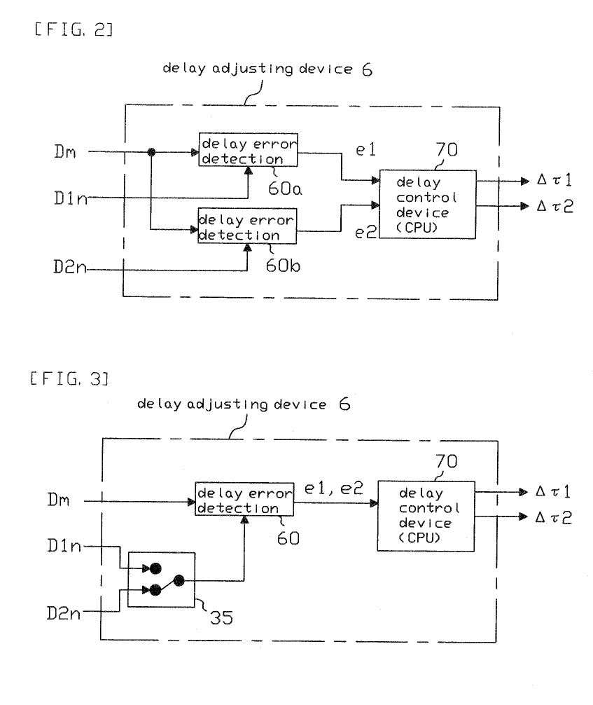

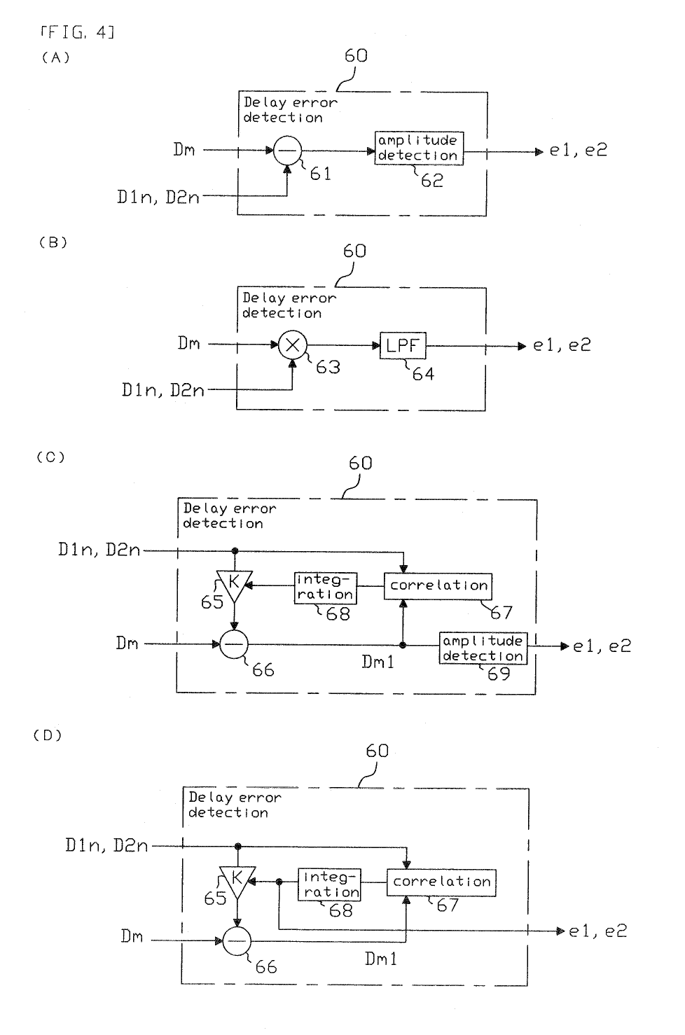

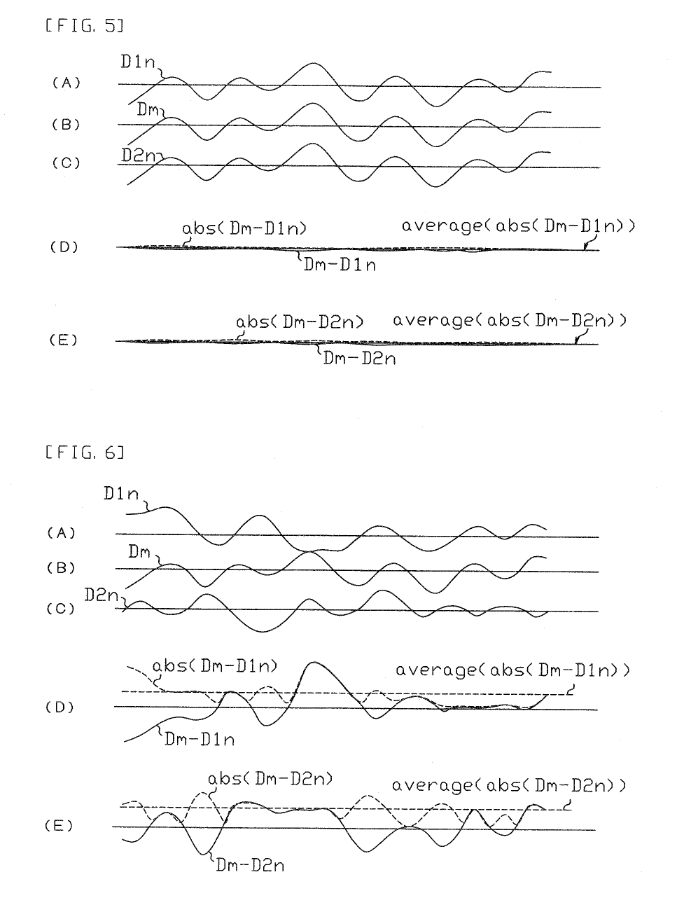

Next, the detailed structure of the delay adjusting device and a delay error detecting device in the first embodiment will be explained with reference to FIG. 2 to FIG. 4. Here, FIG. 2 and FIG. 3 show the configuration examples of the delay adjusting device. FIG. 4(A) to (D) show the specific examples of a delay error detection circuit.

In an example in FIG. 2, the delay adjusting device 6 is provided with: a two-system (or two-line) operation circuit, wherein one is a delay error detection circuit 60a for outputting a change amount corresponding to a delay error difference between the reproduction signal Dm and the reproduction signal D1n, as a delay error signal e1 and the other is a delay error detection circuit 60b for outputting a change amount corresponding to a delay error difference between the reproduction signal Dm and the reproduction signal D2n, as a delay error signal e2; and a delay control device 70, constructed from a CPU, for example, for calculating the delay errors Δτ1 and Δτ2 from the delay error signals e1 and e2 outputted by the delay error detection circuits 60a and 60b and outputting them to the delay devices 5a and 5b, respectively.

The delay adjusting device 6 in an example in FIG. 3 is constructed to selectively input the reproduction D1n or D2n to the delay error detection circuit 60 by using the selector 35 and unify the operation circuits.

The delay error detection circuits 60a, 60b, and the delay error detection circuit 60 are all circuits for outputting an amount corresponding to the phase difference between the two input signals, as the delay error signal. Thus, their specific structure will be explained by using the case of the delay error detection circuit 60 as an example.

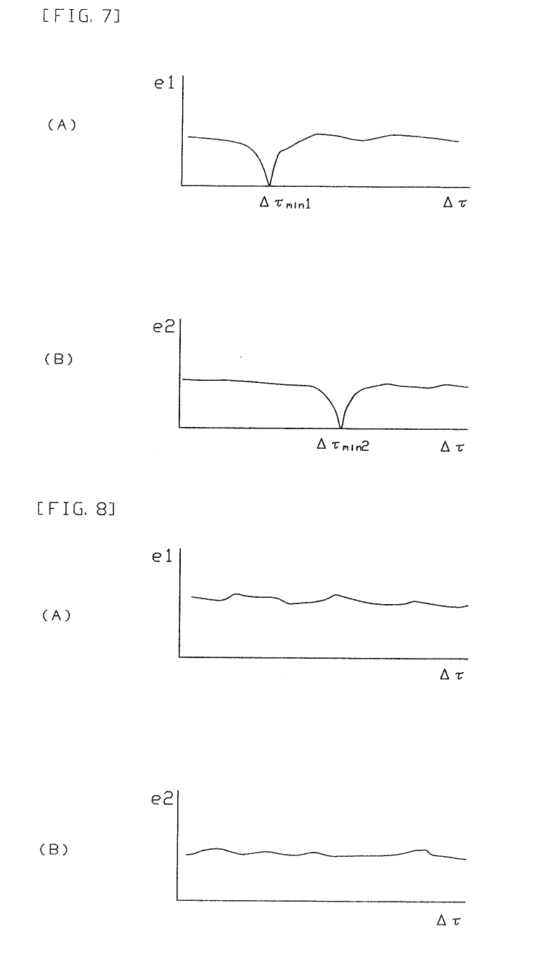

The delay error detection circuit 60 in FIG. 4(A) is provided with: a subtractor 61; and an amplitude detecting device 62, wherein the reproduction signal D1n or D2n is subtracted from the reproduction signal Dm by the subtractor 61 and the mean amplitude value of the subtraction results is obtained by the amplitude detecting device 62 and set as the delay error signal e1 or e2. The subtraction result adopts 0 or a minimum value if the above-mentioned two input reproduction signals are in phase (refer to FIG. 5) and adopts a relatively large value if the above-mentioned two input reproduction signals are out of phase (refer to FIG. 6). Thus, if the input reproduction signals cut by using a time window with a predetermined width are mutually subtracted while the phases between the input reproduction signals are shifted, and if the mean amplitude value of the differences is obtained and regarded as the delay error signal e1 or e2, then, it can be the index of the delay error corresponding to the phase difference.

The delay error detection circuit 60 in FIG. 4(B) is provided with: an accumulator 63; and a LPF (Low Pass Filter) 64 as an integrator, wherein a correlation between the reproduction signal Dm and the reproduction signal D1n or D2n is obtained and this is set as the delay error signal e1 or e2. The correlation in this case adopts a maximum value if the two input reproduction signals are in phase, and adopts a relatively small value if the above-mentioned two input reproduction signals are out of phase. Thus, if the correlation between the input reproduction signals cut by using a time window with a predetermined is obtained while the phase between the input reproduction signals is shifted, and regarded as the delay error signal e1 or e2, then, it can be the index of the delay error corresponding to the phase difference.

The delay error detection circuit 60 in FIG. 4(C) is provided with: a multiplier 65; a subtractor 66; a correlation operating device 67; an integrator 68; and an amplitude detection deice 69. In this case, the mean amplitude of a signal Dm1 is set as the delay error signal e1 or e2, wherein the signal Dm1 is obtained by subtracting a signal that is obtained by multiplying the reproduction D1n or D2n by a coefficient K, from the reproduction signal Dm. The coefficient K is the tap coefficient of the multiplier 65, and is generated by integrating the correlation between the signal Dm1 and the reproduction signal D1n or D2n, for example. The correlation operating device 67 used at that time may have the structure shown in FIG. 4(B), for example, or may be constructed to obtain a correlation value on the basis of other methods. For example, in the example in FIG. 4(A), there is no problem if the signal levels of the reproduction signal Dm and the reproduction signal D1n or D2n are substantially equal. However, if the signal levels of the both are not equal, because the difference value includes a difference in the signal level as information, the information about the phase shift cannot be detected stably from the delay error signal e1 or e2. In contrast, according to this configuration example, even if the reproduction signal Dm and the reproduction signal D1n or D2n have different signal levels, the amplitude of the reproduction signal D1n or D2n is adjusted by the multiplier 65 to set the mean amplitude of the signal Dm1 to be 0 or minimum if the both reproduction signals are in phase (if the delay amount τ1 or τ2 is in an optimally adjusted condition. As a result, it is possible to obtain the error signal e1 or e2 including the highly accurate information about the phase difference.

The delay error detection circuit 60 in FIG. 4(D) obtains the correlation between the reproduction signal Dm and the reproduction signal D1n or D2n in the configuration example in FIG. 4(C) and sets a signal obtained by integrating the correlation, as the delay error signals e1 and e2. In this case, the delay error signal e1 or e2 adopts a maximum value if the two input reproduction signals are in phase and adopts a relatively small value if the two input reproduction signals are out of phase, so that it can be the index of the delay error corresponding to the phase difference.

### (Operation of Reproducing Apparatus)

Next, the operation of the reproducing apparatus in the first embodiment will be explained with reference to FIG. 1 to FIG. 10.

### Operation Example: 1

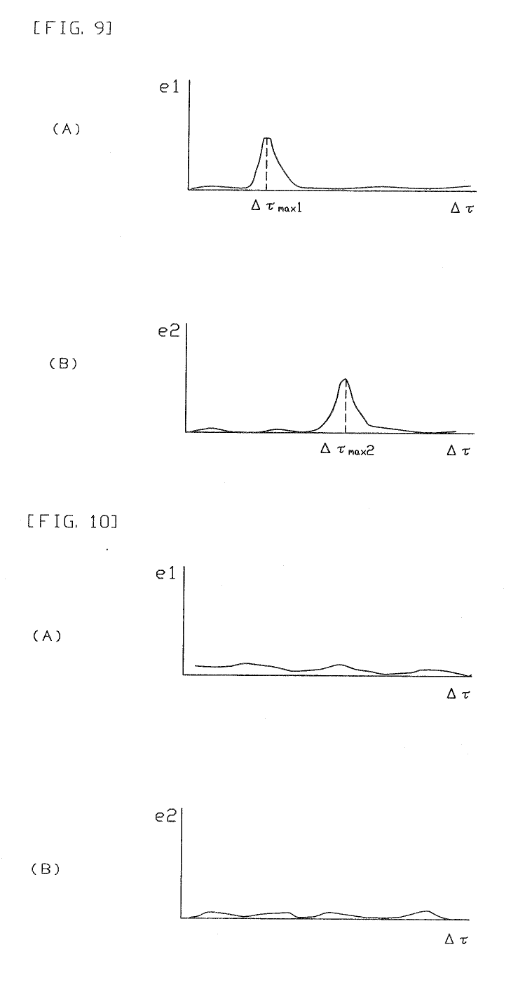

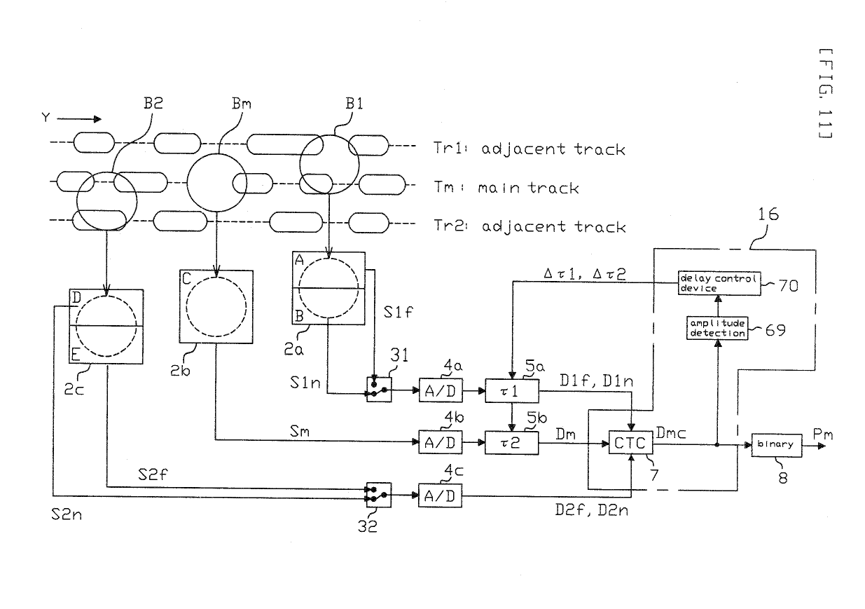

Firstly, a detailed explanation will be given to the case where the structure shown in FIG. 4(A) is adopted to the delay error detection circuit 60. FIG. 5 and FIG. 6 show the respective waveforms of the reproduction signals Dm, D1n, and D2n after the delay, and the operation results (difference value, mean amplitude value) on the delay error detection circuit 60 if the structure shown in FIG. 4(A) is adopted, in the both cases where the delay adjustment is optimum and inappropriate. FIGS. 7(A) and FIG. 7(B) show each change in the error signals e1 and e2 with respect to the phase shift Δτ between the reproduction signal Dm and the reproduction signal D1n, and between the reproduction signal Dm and the reproduction signal D2n. FIGS. 8(A) and FIG. 8(B) show each change in the error signals e1 and e2 with respect to the phase shift Δτ if the reproduction signals D1f and D2f are applied for the delay adjustment, instead of the reproduction signals D1n and D2n, as a comparison example.

If the main track Tm on the optical disc 10 is scanned by using the main beam Bm, and the areas deviated from the main track Tm (refer to FIG. 1) are also scanned by using the sub beams B1 and B2 separated by the main beam Bm back and forth in a track reproduction direction Y, the reflected light or transmitted light from the optical disc 10 based on the sub beam B1, the main beam Bm, and the sub beam B2 is continuously detected by the detectors 2a, 2b, and 2c. The reproduction signal Sm, which is a reading target, is outputted from the light receiving element C of the detector 2b.

The reproduction signals S1f and S1n are outputted from the light receiving elements A and B of the detector 2a, respectively. Here, the reproduction signal S1n is a selected output from the light receiving element B on the side closer to the main track Tm, and mainly includes a signal component read from the main track Tm. A signal component read from the adjacent track Tr1 is slightly included or hardly included in practice. In other words, the reproduction signal S1n can be regarded as the reproduction signal Sm with a different phase. On the other hand, the reproduction signal S1f is a selected output from the light receiving element A on the side farther from the main track Tm, and mainly includes the component read from the main track Tr1. This signal component can be regarded as the index of the crosstalk mixed into the reproduction signal Sm. Incidentally, in the reproduction signal S1f, the signal component read from the main track Tm is slightly included or hardly included in practice.

The reproduction signals S2n and S2f are outputted from the light receiving elements D and E of the detector 2c, respectively. With regard to these, the reproduction signal S2n includes the signal component read from the main track Tm more than the other does, and the reproduction signal S2f includes the component read from the adjacent track Tr1 more than the other does.

Incidentally, in each beam, the wavelength sometimes varies depending on a change in temperature or the like. At that time, the phase difference between the above-mentioned reproduction signals also varies, so that it is necessary to adjust the delay amounts τ1 and τ2 of the delay devices 5a and 5b, on the basis of the actual phase difference between the reproduction signals.

The reproduction signal Sm is converted to the reproduction signal Dm by the A/D converter 4b, and then, inputted to the delay adjusting device 6 and the CTC 7 through the delay device 5b. Moreover, one of the reproduction signals S1n and S1f selected by the selector 31 is inputted to a circuit portion provided with the A/D converter 4a and the delay device 5a. Here, if the reproduction signal S1f is selectively inputted, it is converted to the reproduction signal D1f, then, transmitted through the delay device 5a and inputted to the CTC 7. If the reproduction signal S1n is selectively inputted, it is converted to the reproduction signal D1n, then, transmitted through the delay device 5a and inputted to the delay adjusting device 6.

Moreover, the same is true for the reproduction signals S2n and S2f. The reproduction signal S2f is converted to the reproduction signal S2f by the A/D converter 4c, and then inputted to the CTC 7. The reproduction signal S2n is converted to the reproduction signal S2n and then inputted to the delay adjusting device 6. In this manner, in the first embodiment, the reproduction signals D1n and D2n are used for the process of the delay adjusting device 6, and the reproduction signals D1f and D2f are used for the process of the CTC 7.

On the delay adjusting device 6, firstly, the error signals e1 and e2 are obtained on the delay error detection circuit 60 shown in FIG. 4(A) (or the delay error detection circuits 60a and 60b). On the delay error detection circuit 60 in this case, the average of the absolute value of the signal obtained by subtracting the reproduction signal D1n (or the reproduction signal D2n) from the reproduction signal Dm is operated or calculated as the signal amplitude, and the signal amplitude obtained while the phase shift Δτ between the reproduction signal Dm and the reproduction signal D1n (or the reproduction signal D2n) is outputted as the error signal e1 (or the error signal e2). Incidentally, the signal amplitude may be also defined as a P-P (Peak to Peak) value of the signal that is obtained by subtracting the reproduction signal D1n (or the reproduction signal D2n) from the reproduction signal Dm.

In the condition that the delay amount is optimally adjusted as shown in FIG. 5, the reproduction signal Dm and the reproduction signal D1n (or the reproduction signal D2n) are almost in phase, and its difference in amplitude is extremely small, so that the error signal e1 (or the error signal e2) is almost zero. On the other hand, in the condition that the delay amount is shifted as shown in FIG. 6, not only the difference in amplitude between the reproduction signal Dm and the reproduction signal D1n (or the reproduction signal D2n) but also the error signal e1 (or the error signal e2) are not small.

This is because in the phase comparison with the reproduction signal Dm, the reproduction signals D1n and D2n are specially selected and used, which include the signal component read from the main track Tm in a higher ratio, out of the reproduction signals obtained on the basis of the sub beams B1 and B2. Namely, in the first embodiment, basically, it is a concept to detect the delay error on the basis of the phase difference of the same signal (i.e. the reproduction signal Dm). Thus, it is possible to obtain the delay error at a constant accuracy, regardless of the extent of the crosstalk of the reproduction signal Dm. This means that highly accurate delay adjustment is possible even in the condition that the crosstalk does not occur. Thus, it is possible to deal with the case where the unexpected crosstalk occurs for some reasons, such as defocus and detrack, although normally it does not occur or it is extremely small.

As shown in each of FIGS. 7(A) and FIG. 7(B), the error signals e1 and e2 outputted in this manner sensitively change in accordance with the phase shift Δτ. The delay control device 70 obtains the phase shift Δτ (Δτmin1, Δτmin2) when the inputted error signals e1 and e2 are both minimum. These are the delay errors between the reproduction signal Dm and the reproduction signal D1n and between the reproduction signal Dm and the reproduction signal D2n. Thus, the delay control device 70 obtains the delay errors Δτ1 and Δτ2 with respect to the delay amounts τ1 and τ2, on the basis of the phase shifts Δτmin1 and Δτmin2, and output them to the delay devices 5a and 5b, respectively.

If the reproduction signals D1f and D2f are used for the phase comparison with the reproduction signal Dm, instead of the reproduction signals D1n and D2n, the error signals e1 and e2 obtained by the above-mentioned process are as shown in FIGS. 8(A) and (B), respectively. Namely, the both signals have different signal components, so that their signal amplitude varies independently of the phase shift Δτ, and it does not become small. It is considered that the crosstalk component of the reproduction signal Dm has a waveform similar to those of the reproduction signals D1f and D2f from the vicinity of the adjacent tracks Tr1 and Tr2, and that the error signals e1 and e2 are obtained on the basis of the phase shift between the both signals. However, in that case, the signal amplitude when the crosstalk component is small is as shown in FIG. 8, and there is a possibility that the error signals e1 and e2 cannot be stably detected.

Moreover, if the reproduction signals are used which are read from all the irradiated areas with the sub beams, the signal amplitude as shown in FIG. 8 are superimposed or overlapped to the error signals e1 and e2 as noises. However, here, the reproduction signals D1n and D2n, which are most similar to the reproduction signal Dm, are removed from the reproduction signals obtained by the sub beams B1 and B2 and used, so that the components shown in the drawings are omitted from the error signals e1 and e2, and the delay errors Δτ1 and Δτ2 are stably obtained.

As described above, in the first embodiment, the influence of the signal components other than the reproduction signals Dm on the delay error detection is set extremely low, so that it is possible to detect the error signals e1 and e2, and thus the delay errors Δτ1 and Δτ2, highly accurately and stably. However, the delay amount adjustment is performed in the order of the delay device 5b and then the delay device 5a. If the order is opposite, the setting of the delay amount τ1 on the delay device 5a is changed along with the change in the delay amount τ2 on the delay device 5b. Thus, it needs to be corrected again, or a proper adjustment value needs to be calculated in advance.

On the CTC 7, such an operation is performed that the crosstalk is removed from the reproduction signal Dm by using the signal component from the adjacent track Tr1 of the reproduction signal D1f and the signal component from the adjacent track Tr2 of the reproduction signal D2f. Incidentally, the phases of the reproduction signals Dm, D1f, and D2f on the CTC 7 are uniformed, highly accurately, thanks to the delay amount adjustment performed by the delay adjusting device 6.

As described above, the reproduction signals D1f and D2f include the signal components read from the adjacent tracks Tr1 and Tr2 in a higher ratio, out of the reproduction signals obtained on the basis of the sub beams B1 and B2, and hardly include the signal component read from the main track Tm. Thus, in the crosstalk canceling in this case, mainly, the crosstalk component is removed from the reproduction signal Dm. Namely, in the first embodiment, basically, it is a concept to perform the crosstalk canceling by comparing and removing a different portion between the crosstalk itself and a processed signal. Thus, it is possible to remove the crosstalk from the reproduction signal Dm, selectively and in a higher ratio, and it is possible to stably output the supposed reproduction signal Dmc.

Moreover, the reproduction signals D1f and D2f have a low correlation with the reproduction signal Dm, so that the waveform component, which is the same as the reproduction signal Dm, is hardly subtracted from the reproduction signal Dm. Thus, it is possible to keep a good S/N ratio in the reproduction signal Dmc. Moreover, by this, it is clear that the reproduction signals D1n and D2n (i.e. which include the reproduction signal component from the main track Tm more than the reproduction signal components from the adjacent tracks Tr1 and Tr2) are rather inappropriate for the crosstalk canceling.

### Operation Example: 2

Next, an explanation will be given for the case where the structure shown in FIG. 4(B) is adopted to the delay error detection circuit 60. Incidentally, with regard to the same operation as the operation example 1, the explanation will be omitted, as occasion demands.

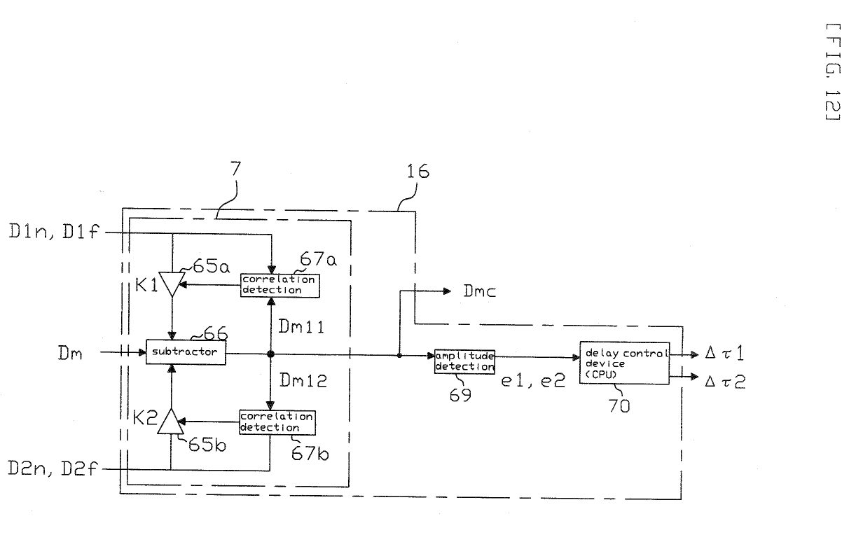

Here, FIGS. 9(A) and (B) show each change in the error signals e1 and e2 with respect to the phase shifts Δτ between the reproduction signals Dm and D1n and between the reproduction signals Dm and D2n. FIGS. 10(A) and (B) show each change in the error signals e1 and e2 with respect to the phase shift Δτ if the reproduction signals D1f and D2f are applied for the delay adjustment, instead of the reproduction signals D1n and D2n, as a comparison example.

On the delay adjusting device 6, the error signals e1 and e2 are obtained on the delay error detection circuit 60 shown in FIG. 4(B) (or the delay error detection circuits 60a and 60b). On the delay error detection circuit 60 in this case, the correlation between the both signals, obtained as a function of the phase shift A r between the reproduction signal Dm and the reproduction signal D1n (or the reproduction signal D2n), is outputted as the error signal e1 (or the error signal e2).

With regard to the error signal e1 (or the error signal e2) obtained at this time, it can be considered that the autocorrelation of the reproduction signal Dm is detected because the reproduction signal D1n (or the reproduction signal D2n) mainly includes the signal component read from the main track Tm, i.e. the component equivalent to the reproduction signal Dm. Therefore, as shown in FIGS. 9(A) and (B), the phase shift Δτ when the error signal e1 (or the error signal e2) is maximum, is the delay error between the reproduction signal Dm and the reproduction signal D1n (or the reproduction signal D2n), i.e. an optimum adjustment value.

The delay control device 70 obtains the phase shift Δτ (Δτ max1, Δτ max2) when each of the inputted error signals e1 and e2 is maximum, obtains the delay errors Δτ1 and Δτ2 with respect to the delay amount τ1 and τ2 on the basis of the phase shift Δτ, and outputs them to the delay devices 5a and 5b, respectively. Here, the reproduction signals D1n and D2n are similar to the reproduction signal Dm, so that the S/N ratios of the error signals e1 and e2 are large and the delay error Δτ1 and Δτ2 can be obtained, highly accurately and stably.

If the reproduction signals D1f and D2f are used for the phase comparison with the reproduction signal Dm, instead of the reproduction signals D1n and D2n, the error signals e1 and e2 obtained by the above-mentioned process are as shown in FIGS. 10(A) and (B), respectively. Namely, the both signals have different signal components and have no correlation, so that the correlation value varies independently of the phase shift Δτ, and it does not become large.

Thus, even in this operation example, the delay adjustment on the delay devices 5a and 5b can be performed regardless of the crosstalk, and it is possible to adjust the delay to the optimum delay amount, highly accurately and stably.

As explained above, in the first embodiment, out of the reproduction signals based on the sub beams B1 and B2, (1) the signal component from the main track Tm is cut as the reproduction signals D1n and D2n and used for the delay amount adjustment, so that the delay error can be captured, relatively clearly, without being buried in noises, and the delay amounts τ1 and τ2 can be set, highly accurately and stably. Moreover, as described above, the delay amounts τ1 and τ2 are adjusted independently of the crosstalk component, so that even if there is not seen any crosstalk or there is a small amount of crosstalk in the reproduction signal Dm, it is possible to properly adjust the delay amounts τ1 and τ2. Therefore, it is possible to perform the proper canceling operation even on the crosstalk which normally does not occur or is extremely small and which occurs irregularly and unexpectedly,

At the same time, (2) the signal components from the adjacent tracks Tr1 and Tr2 are cut as the reproduction signals D1f and D2f and used for the crosstalk canceling, so that the crosstalk component is extracted, more highly accurately, to thereby obtain the reproduction signal Dmc which is more loyal to the record information.

In the first embodiment, the reproduction signals are used in accordance with the purpose of each process as described above, so that it is possible to accurately perform both the delay adjustment and the crosstalk canceling.

### Second Embodiment

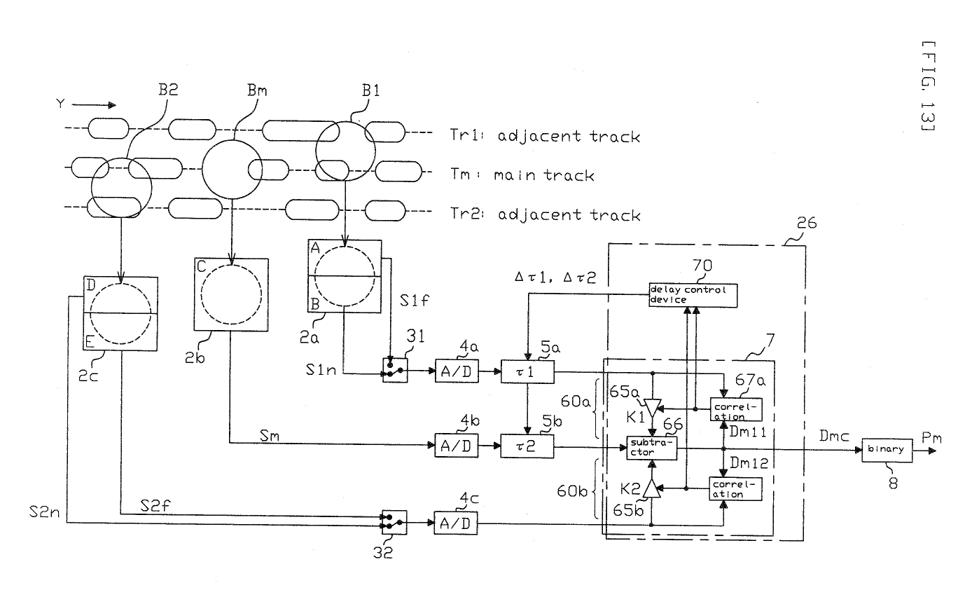

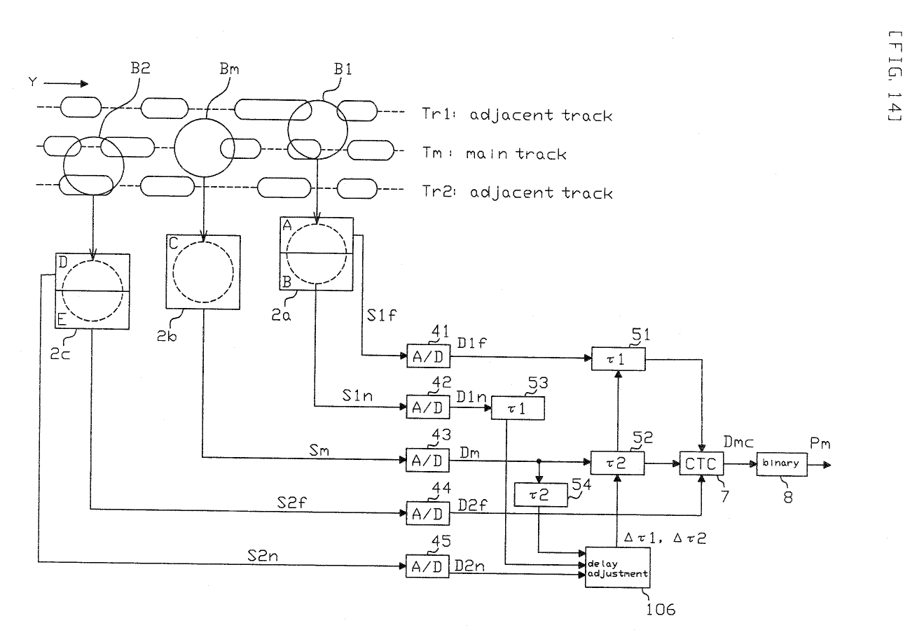

Next, the second embodiment will be explained with reference to FIGS. 11 and FIG. 12. FIG. 11 is a block diagram showing the main structure of a reproducing apparatus in the second embodiment. FIG. 12 is a block diagram showing a configuration example of the delay adjusting device. Incidentally, in the second embodiment, the same constitutional elements as those in the first embodiment carry the same numerical references, and the explanation thereof will be omitted.

In the reproducing apparatus in the second embodiment, the delay error detection circuit 60 having the structure shown in FIG. 4(C) is applied to the reproducing apparatus in the first embodiment, and moreover, the common portion of the delay adjusting device 6 and the CTC 7 is shared.

In FIG. 11, a delay adjusting device 16 includes: the CTC 7 as the previous stage; and the amplitude detection deice 69 and the delay control device 70, as the subsequent stage. FIG. 12 shows the structure of the delay adjusting device 16 in more detail. Namely, here, one portion of the delay error detection circuit 60 and the CTC 7 are shared. The delay error detection circuit 60 is divided into two systems within the CTC 7.

Even here, the reproduction signals D1n and D2n are selectively used for the delay amount adjustment, and the reproduction signals D1f and D2f are selectively used for the crosstalk canceling. Namely, by the same operation control as in the first embodiment, when the reproduction signals D1n and D2n are inputted to the delay adjusting device 16, the output of the CTC 7 is transmitted to the amplitude detection deice 69, and when the reproduction signals D1f and D2f are inputted, the reproduction signal Dmc, which is the original output of the CTC 7, is transmitted to the binary device 8. Thus, each process operation is performed properly. Therefore, in the structure shown in FIG. 11, the CTC 7 is to be operated during the delay adjustment, so that the signal cannot be reproduced during the delay adjustment. However, sharing the circuit allows a reduction in the circuit scale.

In the delay amount adjustment on the delay adjusting device 16, firstly, a signal Dm11 and a signal Dm12 are outputted on the CTC 7 out of the delay error detection circuit 60, wherein the signal Dm11 is obtained by subtracting a signal that is obtained by multiplying the reproduction signal D1n by a coefficient K1, from the reproduction signal Dm, and the signal Dm12 is obtained by subtracting a signal that is obtained by multiplying the reproduction signal D2n by a coefficient K2, from the reproduction signal Dm. The coefficient K1 is the tap coefficient of a multiplier 65a, and is generated as the correlation between the signal Dm11 and the reproduction signal D1n on a correlation operating device 67a, for example. The coefficient K2 is the tap coefficient of a multiplier 65b, and is generated as the correlation between the signal Dm12 and the reproduction signal D2n on a correlation operating device 67b, for example.

The signal Dm11 (Dm12) outputted from the CTC 7 is inputted to the amplitude detection deice 69. On the amplitude detection deice 69, the mean amplitude of the signal Dm11 (Dm12) is obtained and outputted to the delay control device 70 as the delay error signals e1 and e2. Incidentally, the delay error signals e1 and e2 obtained here change as shown in FIGS. 7(A) and (B), respectively. Thus, the delay errors Δτ1 and Δτ2 may be obtained from the phase shift Δτ (Δτmin1, Δτmin2) when the delay error signals e1 and e2 are minimum.

By adjusting the amplitude level of the reproduction signals D1n and D2n as described above, even if the signal level of the reproduction signal Dm is different from the signal level of the reproduction signal D1n or D2n, the mean amplitude, i.e. the S/N ratio of the error signals e1 and e2, can be increased. Thus, it is possible to obtain the delay errors Δτ1 and Δτ2, highly accurately, on the delay control device 70.

Moreover, in the second embodiment, the delay adjusting device 16 and the CTC 7 are partially shared, so that it is possible to reduce the circuit scale.

### Third Embodiment

Next, the third embodiment will be explained with reference to FIG. 13. FIG. 13 is a block diagram showing the main structure of a reproducing apparatus in the third embodiment.

In the reproducing apparatus in the third embodiment, the delay error detection circuits 60a and 60b having the structure shown in FIG. 4(D) are applied to the reproducing apparatus in the first embodiment, and moreover, the common portion of the delay adjusting device 6 and the CTC 7 is shared. In FIG. 13, a delay adjusting device 26 includes: the CTC 7 as the previous stage; and the delay control device 70 as the subsequent stage. Namely, here, two systems of the delay error detection circuits 60a and 60b and the CTC 7 are shared. Moreover, even here, it is constructed such that the reproduction signals D1n and D2n are selectively used for the delay amount adjustment, and the reproduction signals D1f and D2f are selectively used for the crosstalk canceling, on the basis of the same operation control as in the above-mentioned embodiments. Thus, each process operation is performed properly. Therefore, in the structure shown in FIG. 13, the CTC 7 is to be operated during the delay adjustment, so that the signal cannot be reproduced during the delay adjustment. However, sharing the circuit allows a reduction in the circuit scale.

In the delay amount adjustment on the delay adjusting device 26, firstly on the CTC 7, the signal Dm11 is generated by subtracting the signal that is obtained by multiplying the reproduction signal D1n by the coefficient K1, from the reproduction signal Dm, and the signal Dm12 is generated by subtracting the signal that is obtained by multiplying the reproduction signal D2n by a coefficient K2, from the reproduction signal Dm. The coefficient K1 is the tap coefficient of the multiplier 65a, and is generated as the correlation between the signal Dm11 and the reproduction signal D1n on the correlation operating device 67a, for example. The coefficient K2 is the tap coefficient of the multiplier 65b, and is generated as the correlation between the signal Dm12 and the reproduction signal D2n on the correlation operating device 67b, for example. Here, the coefficients K1 and K2 are outputted to the delay control device 70 as the delay error signals e1 and e2, respectively. Incidentally, the delay error signals e1 and e2 obtained here change as shown in FIGS. 9(A) and (B), respectively. Thus, the delay errors Δτ1 and Δτ2 may be obtained from the phase shift Δτ (Δτ min1, Δτmin2) when the delay error signals e1 and e2 are maximum.

Even if such a delay adjusting device 26 is applied, it is possible to obtain the delay errors Δτ1 and Δτ2, highly accurately, as in the above-mentioned each embodiment. Moreover, in the third embodiment, the delay adjusting device 26 and the CTC 7 are partially shared, so that it is possible to reduce the circuit scale.

### Fourth Embodiment

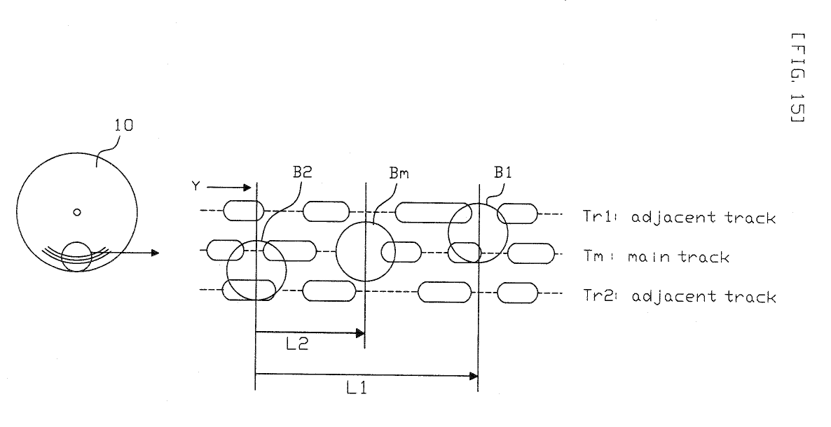

Next, the fourth embodiment will be explained with reference to FIG. 14. FIG. 14 is a block diagram showing the main structure of a reproducing apparatus in the fourth embodiment. The reproducing apparatus in the fourth embodiment is provided with: A/D converters 41 to 45; delay devices 51 to 54; and a delay adjusting device 106, instead of the delay adjusting device 6 in the first embodiment. The delay amounts of the delay devices 51 and 53 are both τ1, and the delay amounts of the delay devices 52 and 54 are both τ2. Then, a signal transmitted through the delay device 54 out of the reproduction signal Dm, a signal transmitted through the delay device 53 out of the reproduction signal D1n, and the reproduction signal D2n are inputted to the delay adjusting device 106.

Namely, the A/D converter 4 and the delay device 5a, which are shared by the reproduction signals S1n and S1f, are divided into two systems which are a route of the A/D converter 41 and the delay device 51, and a route of the A/D converter 42 and the delay device 53 (this is the same for the reproduction signals S2n and S2f), in the structure in the first embodiment (refer to FIG. 1). By virtue of such a structure, the selectors 31 and 32 are removed here, and the five reproduction signal outputs from the detectors 2a to 2c are inputted to the respective A/D converter 41 to 45.

Moreover, the inner structure of the delay adjusting device 106 can be constructed the same as in the delay adjusting device 6, for example. Moreover, as in the delay adjusting devices 16 and 26 in the second and third embodiments, at least one portion of the delay adjusting device 106 may be shared with the CTC 7.

As descried above, the reproducing apparatus and the reproducing method are specifically explained, however, further modification can be made for the reproducing apparatus and the reproducing method of the present invention. Thus, modified examples related to the above-mentioned embodiments will be explained below.

### First Modified Example

### How to Set Delay Amount

In each of the above-mentioned embodiments, the delay amount of the delay device is corrected by using the delay errors Δτ1 and Δτ2 inputted from the delay adjusting device. However, the present invention can be also constructed such that the proper values of the delay amounts τ1 and τ2 are inputted to the delay device, and that the delay amounts τ1 and τ2 themselves are set again by using the proper values. In that case, the delay amounts τ1 and τ2 themselves are detected, so that the input signals to the delay amount setting device is the reproduction signals Dm, D1n, and D2n before the delay.

### Second Modified Example

### How to Obtain Delay Error or Adjustment Amount

In the above-mentioned embodiments and the first modified example, the delay errors Δτ1 and Δτ2 (or the delay amounts τ1 and τ2) are obtained separately on the basis of the reproduction signals D1n and D2n, respectively. However, one of the delay errors Δτ1 and Δτ2 (or the delay amounts τ1 and τ2) may be obtained on the basis of the other value.

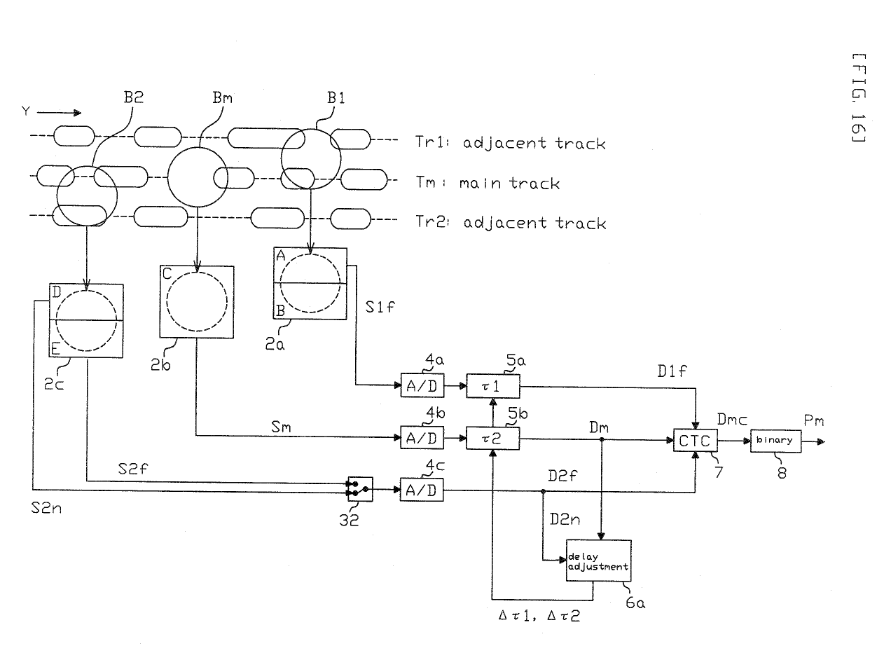

A distance between beams with which the optical disc 10 is irradiated, has a proportional relation with a scan time interval, i.e. the phase difference. As shown in FIG. 15, it is assumed that a distance L1 is from the sub beam B2 to the sub beam B1 and that a distance L2 is from the sub beam B2 to the main beam Bm. The delay amount of the delay device 5a can be obtained as a function of the delay amount τ2 of the delay device 5b, from an equation 1.

τ1=τ2×L1/L2 (1)

Moreover, the delay error Δτ1 of the delay device 5a can be obtained from the following equation 2 which is obtained from the equation 1.

Δτ1=Δτ2×L1/L2 (1)

Here, the delay amounts τ1 and τ2, and the delay errors Δτ1 and Δτ2 are variables, and the delay amounts τ1 and τ2 are the set values of the delay devices 5a and 5b at the present time.

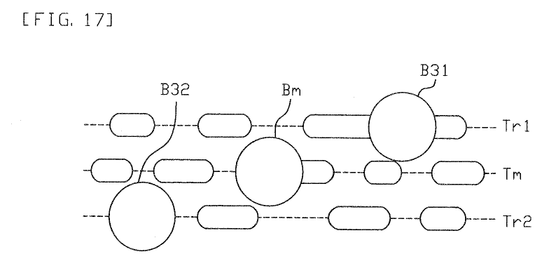

FIG. 16 shows a configuration example if such a modification is applied to the first embodiment. Here, a delay adjusting device 6a is constructed to obtain the delay error Δτ2 as in the first embodiment, and to obtain the delay error Δτ1 from the equation 2. Thus, it is only necessary to input the reproduction signals S2n and Sm to the delay adjusting device 6a, and as the output from the detector 2a, the reproduction signal S1n is unnecessary, and only the reproduction signal S1f is used at the subsequent stage (this is why the selector 31 is removed). In this modified example, the delay error Δτ1 which optimally sets the delay amount τ1 is obtained on the basis of the previously obtained delay error Δτ2 which optimally sets the delay amount τ2. Therefore, the delay adjusting device 6a only needs almost one system structure, which allows simplification and which allows a reduction by half in a processing time length related to the delay amount setting.

Incidentally, the similar modification can be also applied to the fourth embodiment, for example. A delay adjusting device in that case may be constructed to obtain the delay error Δτ2 and to obtain the delay error Δτ1 from the above-mentioned equation 2.

### Third Modified Example

### Irradiated Area of Sub Beam

Incidentally, in the above-mentioned embodiments, in order that each of the sub beams B1 and B2 can read the signal components from both the main track and the adjacent tracks as well as possible, each of the irradiated areas of the sub beams B1 and B2 is an area centered between the main track Tm and the adjacent tracks Tr1 and Tr2. However, the sub beam of the present invention is not limited to this, and modification can be made with regard to an irradiated position, an irradiated range, or the like, for example.

FIG. 17 shows sub beams (sub beams B31 and B32) of a normal 3 beam type. The sub beams may be irradiated onto the adjacent tracks in this manner. Even in that case, by using the divided sub signal detecting device of the present invention, at least the “first sub reproduction signal” obtained from the light receiving portion on the main track side has the signal component from the main track, in a relatively higher ratio, as compared to the sub reproduction signals obtained from the other light receiving portions. Therefore, if the first sub reproduction signal is applied to the delay adjustment, it is possible to obtain such an effect that the delay adjustment is possible even if the crosstalk is small.

Incidentally, as is clear from the fact that the irradiated areas of the sub beams are allowed as described above, the reproduction signals from the sub beams used for the crosstalk canceling, are not necessarily the reproduction signals S1f and S2f. For example, it is possible to use the reproduction signals obtained from all the detectors 2a and 2c.

Moreover, in the above-mentioned embodiments, each of the detectors 2a and 2c is divided into two. However, the detector corresponding to the sub beam may be divided into more portions in a direction of crossing the main track Tm, or in other directions, in order to use the divided detectors in accordance with the signal process, for example. In that case, it is only necessary to use the reproduction signal obtained from the portion on the main track Tm side out of the detector, for the delay amount setting or the delay adjustment.

The present invention is not limited to the above-described embodiments, and various changes may be made, if desired, without departing from the essence or spirit of the invention which can be read from the claims and the entire specification. A reproducing apparatus and a reproducing method, which involve such changes, are also intended to be within the technical scope of the present invention.

Here, the “recording medium” of the present invention is a medium on which recording and reproduction from a track can be performed in response to beam irradiation, and it indicates a disc-shaped recording medium with orbiting tracks and a recording medium with linear tracks, such as a CD (Compact Disk), various types of DVD, MD (Mini Disk), and MO (Magneto Optical disk), for example. Moreover, the “track” of the present invention indicates a linearly continuous portion for recording and reproducing the information on the recording medium. It may be formed in a groove shape or in a land shape, or it may be a pit row without the groove and the land.

### INDUSTRIAL APPLICABILITY

The reproducing apparatus and the reproducing method according to the present invention can be applied to a reproducing apparatus for and a reproducing method of removing crosstalk components from adjacent tracks, from a reproduction signal which is a reading target, on the basis of a plurality of reproduction signals obtained by irradiating a recording medium, such as an optical disc, with a plurality of beams.

1. A reproducing apparatus comprising:
a beam irradiating device for irradiating a main beam onto one track which is a reading target on a recording medium, and for irradiating a sub beam onto a position shifted from an irradiated position of the main beam;
a main signal detecting device for detecting light from the recording medium based on the irradiated main beam and for outputting a main reproduction signal;
a sub signal detecting device having a plurality of light receiving portions including a first light receiving portion on a side closer to the one track and divided by a dividing line along a tangential direction of the one track, said sub signal detecting device for outputting a plurality of sub reproduction signals including a first sub reproduction signal corresponding to light from the recording medium based on the sub beam detected by the first light receiving portion;
a delay device for relatively delaying one of the outputted main reproduction signal and at least one of the outputted plurality of sub reproduction signals, with respect to the other signal;
a delay amount setting device for setting a delay amount of said delay device, on the basis of the first sub reproduction signal; and
a crosstalk canceller for removing crosstalk caused by another track adjacent to the one track, from the outputted main reproduction signal, on the basis of an output of the delay device.

2. The reproducing apparatus according to claim 1, wherein said delay amount setting device detects a delay error between the first sub reproduction signal and the main reproduction signal relatively delayed by said delay device, and sets the delay amount in accordance with the delay error.

3. The reproducing apparatus according to claim 2, further comprising a signal selecting device for changing the outputted plurality of sub reproduction signals for said delay amount setting device and for said crosstalk canceller, and for selectively outputting the signals to said delay device.

4. The reproducing apparatus according to claim 1, wherein said crosstalk canceller is controlled in a condition that the crosstalk is not removed from the outputted main reproduction signal at the time of delay adjustment.

5. The reproducing apparatus according to claim 1, wherein
the plurality of light receiving portions include a second light receiving portion on a side farther from the one track, and
said crosstalk canceller removes the crosstalk by using a second sub reproduction signal corresponding to light from the recording medium based on the sub beam detected by the second light receiving portion out of the sub reproduction signals.

6. The reproducing apparatus according to claim 1, wherein the sub beam is irradiated centered on a gap between the one track and the another track.

7. The reproducing apparatus according to claim 1, wherein said delay amount setting device sets the delay amount on the basis of an amplitude difference between the main reproduction signal and the first sub reproduction signal.

8. The reproducing apparatus according to claim 7, wherein said delay amount setting device performs adjustment of adding or subtracting an amplitude value of the first sub reproduction signal, by using a coefficient based on a correlation between the amplitude difference and the first sub reproduction signal.

9. The reproducing apparatus according to claim 1, wherein said delay amount setting device sets the delay amount on the basis of a correlation between the main reproduction signal and the first sub reproduction signal.

10. The reproducing apparatus according to claim 1, wherein said delay amount setting device sets the delay amount on the basis of a correlation between the first sub reproduction signal and an amplitude difference between the main reproduction signal and the first sub reproduction signal.

11. The reproducing apparatus according to claim 1, wherein at least one portion of said delay amount setting device is shared with said crosstalk canceller.

12. The reproducing apparatus according to claim 1, wherein
said beam irradiating device irradiates two beams separated by the main beam back and forth in a direction along the one track, as the sub beam, and
said sub signal detecting device outputs the sub reproduction signals to two systems in response to each of the two beams.

13. The reproducing apparatus according to claim 12, wherein
the delay amount of the sub reproduction signal corresponding to one of the two beams is set on the basis of the delay amount of the sub reproduction signal corresponding to the other of the two beams, and a mutual distance between each of the two beams and the main beam.

14. A reproducing method comprising:
a beam irradiating process of irradiating a main beam onto one track which is a reading target on a recording medium, and of irradiating a sub beam onto a position shifted from an irradiated position of the main beam;
a main signal detecting process of detecting light from the recording medium based on the irradiated main beam and of outputting a main reproduction signal;
a sub signal detecting process, using a sub signal detecting device having a plurality of light receiving portions including a first light receiving portion on a side closer to the one track and divided by a dividing line along a tangential direction of the one track, to thereby detect light from the recording medium based on the sub beam from each of the plurality of light receiving portions, and output a plurality of sub reproduction signals including a first sub reproduction signal corresponding to light from the recording medium detected by the first light receiving portion;
a delay process of relatively delaying one of the outputted main reproduction signal and at least one of the outputted plurality of sub reproduction signals, with respect to the other signal;
a delay amount setting process of setting a delay amount in the delay, on the basis of the first sub reproduction signal; and
a crosstalk canceling process of removing crosstalk caused by another track adjacent to the one track, from the outputted main reproduction signal, on the basis of at least one of the plurality of sub reproduction signals, after said delay process.
